(19) United States
(12) Patent Application Publication
(10) Pub. No.: US 2011/0290620 A1
(43) Pub. Date: Dec. 1, 2011

(54) GRAVITY CONVEYOR SYSTEM HAVING SUSPENDED CARRIERS

(75) Inventor: Michael J. O'Brien, Richmond, MI (US)

(73) Assignee: BLEICHERT FOERDERANLAGEN GMBH, Osterburken (DE)

(21) Appl. No.: 12/791,136

(22) Filed: Jun. 1, 2010

(51) Int. Cl. B65G 47/74

(52) U.S. Cl. 198/562

(57) ABSTRACT

A gravity conveyor assembly includes a first track member downwardly pitched from a first end toward a second end with respect to a first reference plane oriented parallel to a ground surface. A second track member positioned directly above the first track member is downwardly pitched from a first end toward an opposite second end with respect to a second reference plane oriented parallel to the ground surface. A curved track member connects the second track member second end to the first track member first end and defines a vertically downward oriented arc. A wheeled cart is moveable from the second track member first end to the first track member second end by gravity. A cart travel direction reverses from a first travel direction on the second track member to an opposite second travel direction on the first track member as the cart downwardly traverses the curved track member.

### FIELD

The present disclosure relates to conveyor systems having inclined support rails that allow gravity induced motion of conveyed product carriers.

### BACKGROUND

This section provides background information related to the present disclosure which is not necessarily prior art.

Known gravity conveyor systems such as those disclosed in U.S. Pat. No. 4,359,945 to Brems et al. and U.S. Pat. No. 4,215,772 to Graham provide rail tracks that are made of thin metal material having intermittently provided support members. The spacing of the support members can allow distortion in the unsupported portions of the track and therefore allow for discontinuous slope of the track, resulting in either undesirable increased or decreased speed of carrier motion. These track systems also provide for only a single motion plane of the carriers, which increases the floor space area required for the track system.

Conveyor systems such as the Brems et al. and Graham systems also do not provide for retention of the pallet except as directly supported by the rails. Moving pallets that contact each other or that contact non-moving pallets on the rail (i.e., at stop, loading, or un-loading points) can cause one or more of the pallets to jump off the rail.

### SUMMARY

This section provides a general summary of the disclosure, and is not a comprehensive disclosure of its full scope or all of its features.

According to several embodiments, a gravity conveyor assembly includes a first track member oriented at a downward pitch starting from a first end downward toward an opposite second end with respect to a first reference plane oriented parallel to a ground surface. A second track member is positioned directly above the first track member and is oriented at a downward pitch starting from a second track member first end downward toward an opposite second track member second end with respect to a second reference plane oriented parallel to the ground surface. A first curved track member connects the second track member second end to the first track member first end. The first curved track member defines a vertically downward oriented arc. A cart has at least one wheel moveable from the second track member first end to the first track member second end by gravity, a direction of travel of the cart reversing from a first direction of travel on the second track member to an opposite second direction of travel on the first track member as the cart downwardly traverses the first curved track member.

According to further embodiments, a gravity conveyor assembly includes a first track member continuously downwardly pitched starting from a first end toward an opposite second end. A second track member is positioned entirely above the first track member, the second track member continuously downwardly pitched starting from a second track member first end toward an opposite second track member second end. A first curved track member connects the second track member second end to the first track member first end. The first curved track member defines a vertically downward oriented arc. A second curved track member connects the second end of the first track member to the first end of the second track member. The second curved track member defines a vertically upward oriented arc. A cart having at least one wheel is moveable from the second track member first end to the first track member second end by gravity. A direction of travel of the cart reverses from a first direction of travel on the second track member to an opposite second direction of travel on the first track member as the cart traverses the first curved track member from the second track member to the first track member. The cart is movable against gravity in the upward oriented arc of the second curved track member to return the cart from the first track member to the second track member.

According to still further embodiments, a gravity conveyor assembly includes a vertically looped conveyor, including: a first track member oriented at a downward pitch starting from a first end downward toward an opposite second end with respect to a first reference plane oriented parallel to a ground surface, and a second track member positioned directly above the first track member and oriented at a downward pitch starting from a second track member first end downward toward an opposite second track member second end with respect to a second reference plane oriented parallel to the ground surface. A first curved track member connects the second track member second end to the first track member first end, the first curved track member defining a downward oriented arc. A movable cart transfer device includes an upper track portion adapted to support a plurality of carts and aligned so that the carts move by gravity induced motion onto the first track member of the vertically looped conveyor assembly. A lower track portion is aligned with the first track member to receive any of the carts positioned on the first track member by gravity induced motion. The carts when received on the lower track portion have a product support surface oriented downward, opposite to an upward orientation of the product support surface for any of the carts positioned on the upper track portion or the first track member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevational view of a gravity conveyor system having suspended carriers of the present disclosure;

FIG. 2 is a front elevational view of the unloading conveyor portion of the gravity conveyor system of FIG. 1;

FIG. 3 is a front elevational view of the loading conveyor portion of the gravity conveyor system of FIG. 1;

FIG. 4 is a front elevational view of another embodiment of a gravity conveyor system of the present disclosure;

FIG. 5 is a front elevational view of area 5 of FIG. 4;

FIG. 6 is a front elevational view of area 6 of FIG. 4;

FIG. 7 is a front elevational view of the modified movable cart transfer device of FIG. 5;

FIG. 8 is a front right perspective view of a curved track assembly of the present disclosure;

FIG. 9 is a front elevational view of a portion of the curved track assembly of FIG. 8; and

FIG. 10 is a cross sectional end elevational view of a track cart of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth (i.e., examples of specific components, devices, and methods) to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected. or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, the device may be otherwise oriented (rotated 90 degrees or at other orientations as viewed in the plan view) and the spatially relative descriptors used herein interpreted accordingly.

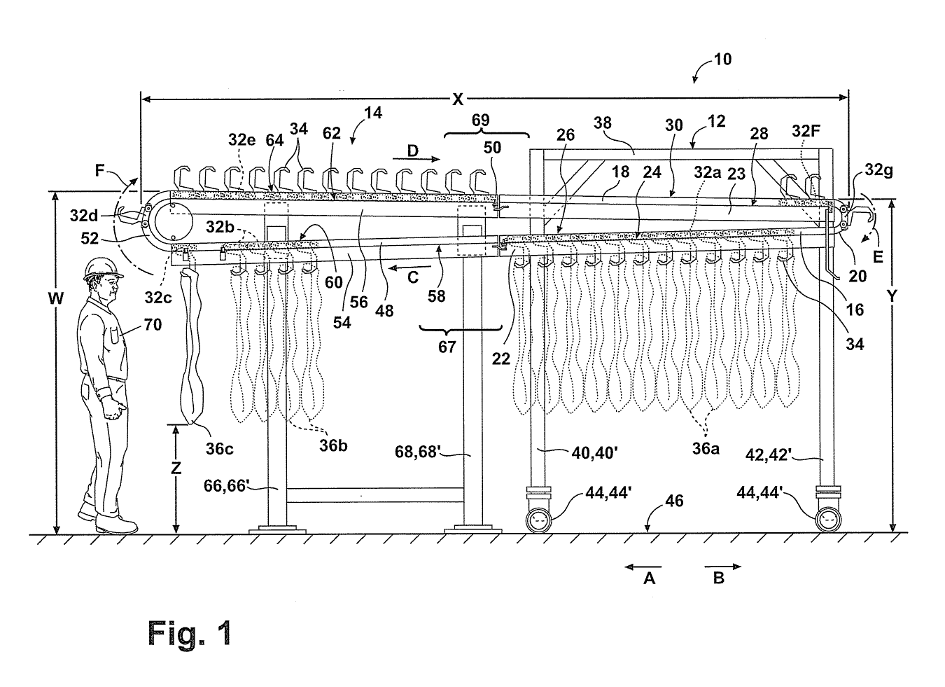

Referring to FIG. 1, a gravity conveyor system 10 includes a loading conveyor portion 12 which is releasably connected to an unloading conveyor portion 14. Loading conveyor portion 12 can include a first track section 16 which is positioned entirely below a second track section 18. A track down-turn section or first curved track member 20 is arc-shaped or semicircular and connects the first track section 16 to the second track section 18. At least one track support structure 22 supports an entire length of the first track section 16. Similarly, at least one track support structure 23 supports an entire length of the second track section 18. First track section 16 further includes a cart support portion 24 and a cart retention portion 26. Similarly, second track section 18 includes a cart support portion 28 and a cart retention portion 30.

First and second track sections 16, 18 and first curved track member 20 support and provide for gravity induced motion of a plurality of transport carts 32. According to several embodiments, each of the transport carts 32 includes a hook member 34. The hook member 34 of each of the transport carts 32 is provided to support by suspension a plurality of components 36, shown as components 36a under first track section 16, which are loaded prior to transport to the unloading conveyor portion 14. First and second track sections 16, 18 as well as first curved track member 20 are connected to and supported by a frame 38 which is constructed using first stanchions 40, 40′ and second stanchions 42, 42′ (first stanchion 40′ and second stanchion 42′ are not visible in this view). Each of the first and second stanchions 40, 40′, 42, 42′ are supported by a plurality of wheels 44, 44′ such that loading conveyor portion 12 can be moved with respect to a ground surface 46 and also with respect to unloading conveyor portion 14. In contrast to loading conveyor portion 12, unloading conveyor portion 14 is fixedly connected to ground surface 46. According to additional embodiments, either or both of loading and unloading conveyor portions 12, 14 can include wheels for movement or be fixed to the ground surface 46.

Unloading conveyor portion 14 can include a third track section 48 and a fourth track section 50 having third track section 48 positioned below the fourth track section 50. A generally arc-shaped or semicircular track up-turn section or second curved track member 52 connects third track section 48 to fourth track section 50. A track support structure 54 supports the third track section 48 along its entire length. Similarly, a track support structure 56 supports the fourth track section 50 along its entire length. Third track section 48 further includes a support track portion 58 and a retention track portion 60. Similarly, fourth track section 50 includes a support track portion 62 and a retention track portion 64. Unloading conveyor portion 14 is fixedly connected to the ground surface 46 using each of third stanchions 66, 66′ and fourth stanchions 68, 68′ (third stanchion 66′ and fourth stanchion 68′ are not visible in this view).

Loading conveyor portion 12 can be releasably coupled to unloading conveyor portion 14 by moving loading conveyor portion 12 in a conveyor connecting direction “A”. To release loading conveyor portion 12, loading conveyor portion 12 is moved oppositely in a conveyor disconnecting direction “B.” When loading conveyor portion 12 is connected to unloading conveyor portion 14, the components 36a can displace under the force of gravity in a component delivery direction “C” from support portion 24 onto support track portion 58 of unloading conveyor portion 14. Components 36b are shown in the retaining position on unloading conveyor portion 14 prior to being individually moved to the position shown at component 36c where component 36c is manually unloaded by an operator 70. The transport carts 32 supporting the components 36 translate under the force of gravity by rolling from the position shown as transport carts 32a to the temporary position shown at transport carts 32c prior to the components 36b being unloaded. Once the individual transport cart 32c has been unloaded, transport cart 32c is returned from third track section 48 to fourth track section 50 by movement along the second curved track member 52. Movement of carts on the second curved track member 52 is about an upward rotation arc “F” and is shown for example as transport cart 32d. After return to fourth track section 50, the plurality of empty transport carts 32e can be retained on support track portion 62 until their release in the empty cart return direction “D” back to second track section 18 where they are identified as transport carts 32f. From the position shown as transport carts 32f the transport carts can be moved back to first track section 16 by following the path provided by first curved track member 20 in a downward rotation arc “E.” Transport cart 32g is representative of a cart being transferred on first curved track member 20.

Components 36 are therefore suspended by the plurality of hook members 34 of the transport carts 32 from each of first track section 16 and third track section 48. Empty transport carts 32 returned along second curved track member 52 each have their hook members 34 reversed or facing upward when supported from either second track section 18 or fourth track section 50. The various track sections of gravity conveyor system 10 are therefore completely contained on a continuous loop path so that empty transport carts 32, such as transport carts 32e or 32f, can be moved back to the lower track sections and reused for transporting components 36 to an off load station by the operator 70.

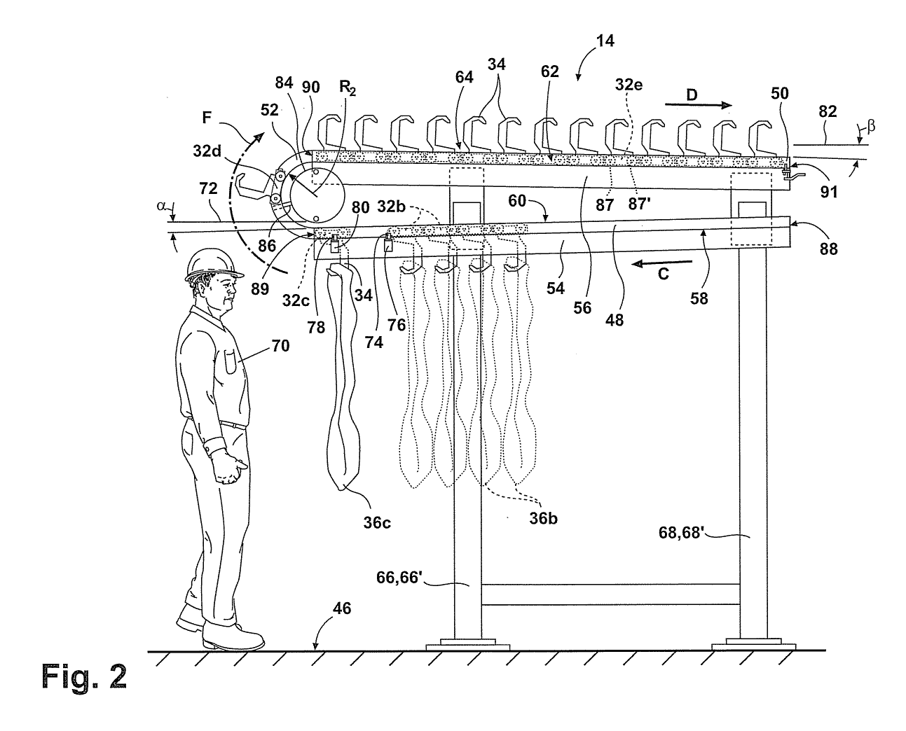

Referring to FIG. 2, unloading conveyor portion 14 is shown in greater detail. A first track pitch angle α of third track section 48 is determined with respect to a reference plane 72 oriented parallel to ground surface 46. According to several embodiments the track slope is defined by pitch angle α which can range from approximately 0.25 degrees to 2.0 degrees inclusive. The specific pitch angle chosen within this range is used as a constant slope for the third track section 48. A pitch or slope of fourth track section 50 is oriented downward in an opposite direction with respect to third track section 48 and defines an angle β measured with respect to a reference plane 82 which is oriented parallel with respect to ground surface 46. According to several embodiments angle β is substantially equal to angle α. Transport carts 32b and 32c will therefore move under the force of gravity in the component delivery direction “C” while transport carts 32e on fourth track section 50 will move in the empty cart return direction “D” due to the pitch of fourth track section 50 at angle β. According to several embodiments component delivery direction “C” is substantially oppositely directed with respect to empty cart return direction “D”.

Transport carts 32b holding components 36b are retained at the temporary stop position shown by upward extension of a displacement member 74 from a first stop device 76 which can be connected to track support structure 54. Displacement member 74 can be either automatically or manually triggered to displace downwardly to release individual ones of the transport carts 32b for displacement to the offloading position shown as transport cart 32c. When reaching the offload position shown by transport cart 32c, transport cart 32c is temporarily held in the offload position by the upward displacement of a displacement member 78 of a second stop device 80 which can also be connected to track support structure 54.

After component 36c is removed from transport cart 32c, displacement member 78 can be retracted to second stop device 80 to release transport cart 32c (now empty) for return travel about second curved track member 52 for return to fourth track section 50. An indexing device 84 rotatably connected to one or both of track support structures 54, 56 includes at least one indexing arm 86 which is provided to contact transport cart 32c and push transport cart 32c about the upward rotation arc “F” of second curved track member 52 to return the transport cart identified as transport cart 32d to fourth track section 50. Indexing arm 86 continues then to rotate about the upward rotation arc “F” to return indexing arm 86 to receive the next transport cart 32c. Each of the transport carts 32 have at least one and according to several embodiments four concave perimeter wheels 87 which rotate as the transport carts 32 move along one of the track sections of gravity conveyor system 10.

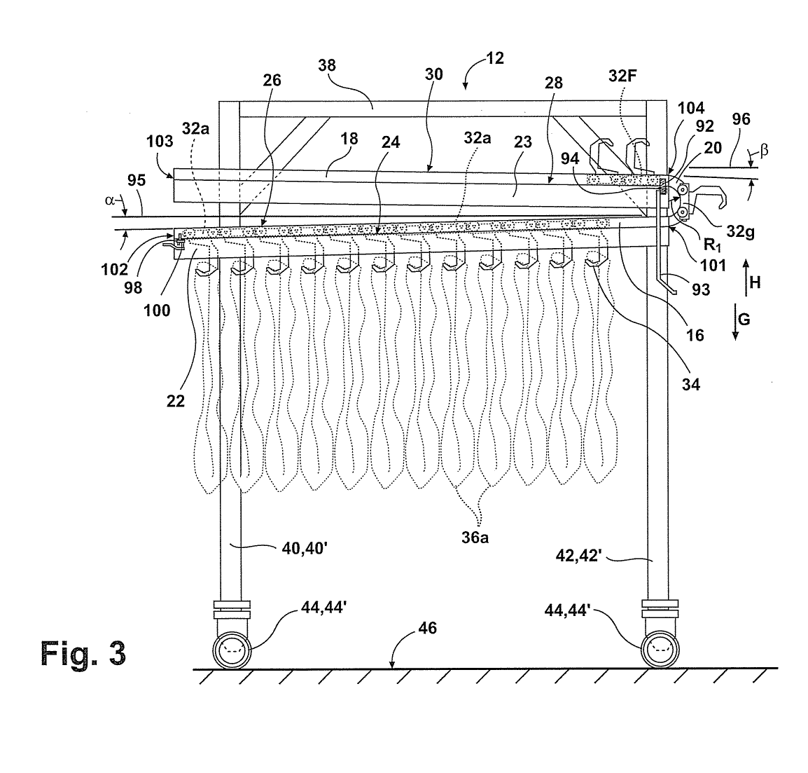

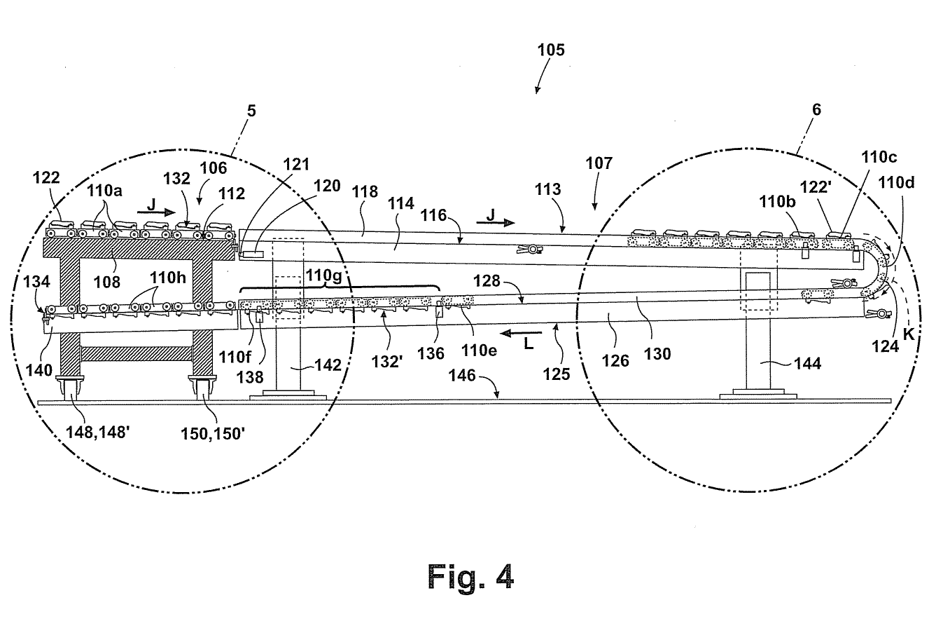

Referring to FIG. 3, further details of loading conveyor portion 12 can include a retractable pin 92 movable downward to a cart release position by a manual displacement lever 93. Retractable pin 92 can be biased to a cart engagement or extended position shown by a biasing member 94 such that retractable pin 92 will retain one or more of the transport carts identified as transport carts 32f so that transport carts can be individually selected for return from second track section 18 to first track section 16. Retractable pin 92 can be downwardly displaced in a manual released direction “G” using manual displacement lever 93 which overcomes the biasing force of biasing member 94 to downwardly displace retractable pin 92. The individual transport carts 32f move into the first curved track member 20 as shown by transport cart 32g for return to first track section 16. When manual displacement lever 93 is released, retractable pin 92 is returned to the upward or extended position by the biasing force of biasing member 94. Retractable pin 92 can also be automatically operated by substituting a powered operator such as shown and described in reference to FIGS. 4-7 for retractable pin 92, manual displacement lever 93, and biasing member 94.

With reference again to FIG. 2, the third track member or section 48 is oriented at the downward pitch or angle α, starting from an elevated section first end 88 downward toward an opposite section second end 89 with respect to the reference plane 72 oriented parallel to the ground surface 46. The fourth track member or section 50 is positioned above the third track section 48 and is oriented at downward pitch or angle β starting from a fourth track section first end 90 downward toward an opposite second track section second end 91 with respect to reference plane 82 oriented parallel to the ground surface 46. The second curved track member 52 connects the third track section second end 89 to the fourth track section first end 90.

With reference again to FIG. 3, the first track member or section 16 is oriented at the downward pitch or angle α, starting from an elevated first track section first end 101 downward toward an opposite section second end 102 with respect to the first reference plane 95 oriented parallel to the ground surface 46. The second track member or section 18 is positioned above the first track section 16 and is oriented at downward pitch or angle β starting from a second track section first end 103 downward toward an opposite second track section second end 104 with respect to a second reference plane 96 oriented parallel to the ground surface 46. The first curved track member 20 connects the second track section second end 104 to the first track section first end 101.

As previously noted, according to several embodiments angle α is equal to angle β such that the track sections of the present disclosure have equal pitch to maintain a substantially equal travel speed for the transport carts. It is also noted, however, that because of the weight of the components 36 (identified as components 36a), angle α can be varied with respect to angle β to further control a transport speed that may vary between a loaded and an unloaded transport cart 32.

Referring again to FIGS. 1-3, with loading conveyor portion 12 either releasably or fixedly connected to unloading conveyor portion 14, first track section 16 and third track section 48 can be considered a first unitary track section 67 providing a continuous, collinear downward path for cart travel from first track section first end 101 of first track section 16 to third track section second end 89 of third track section 48. Similarly, a second unitary track section 69 provides a continuous, collinear downward path for cart travel from fourth track section first end 90 of fourth track section 50 to second track section second end 104 of second track section 18. With first curved track member 20 installed, a continuous, downward pitched path is therefore created from fourth track section first end 90 of fourth track section 50 to third track section second end 89 of third track section 48. When second curved track member 52 is included, a closed loop is provided for gravity conveyor system 10.

With still further reference to FIGS. 1-3, a radius R₁ of first curved track member 20 is a minimum bend radius required to provide clearance for motion of transport carts 32g about the path of first curved track member 20. Because radius R₁ of first curved track member 20 cannot be reduced below the minimum bend radius, in order to maintain a working conveyor height “W” as a desired conveyor length “X” increases while also maintaining the required pitch of both the upper track sections 50, 18 and lower track sections 16, 48, a radius R₂ of second curved track member 52 can be selected to suit gravity conveyor system 10 dimensions, but is always larger than radius R₁. This permits maintaining a minimum conveyor height “Y” such that a ground clearance dimension “Z” can be maintained between ground surface 46 and the lowest suspended point of any of the components 36. Ground clearance dimension “Z” will be a minimum between the ground surface 46 and the lowest point of component 36c. Ground clearance dimension “Z” can be selected when conveyor length “X” is known while also accommodating the optimum access for off-loading components 36 by operator 70. Although radius R₁ can be larger than the minimum bend radius required for cart transfer, increasing radius R₁ requires a corresponding increase in the dimension of radius R₂.

According to additional embodiments, a gravity conveyor system 105 includes each of a movable cart transfer device 106 and a vertically downward connected direction reversing conveyor assembly 107. Movable cart transfer device 106 can include an upper track support 108 which can support a plurality of carts 110 shown as carts 110a from a cart upper track portion 112. Cart upper track portion 112 is aligned so that carts 110a can move by gravity induced motion onto an unloading upper cart track 113 having a track support structure 114 with an integral upper track support portion 116 of direction reversing conveyor assembly 107 in an offload transit direction “J.” Unloading upper cart track 113 further integrally provides an upper track cart retention portion 118 and can support a contact signaling device 120. Contact signaling device 120 signals when a connection is made between movable cart transfer device 106 and direction reversing conveyor assembly 107 (i.e., by depression of a contact member 121).

Each of the carts 110a have a product 122 supported therefrom for rolling transfer on unloading upper cart track 113 to a temporary stop position shown at cart 110b. Individual ones of carts 110b are moved to the offload position (shown as cart 110c) where the product 122′ is offloaded. The now empty carts 110d are thereafter individually released for travel along a downward curved track portion 124 which is substantially arc-shaped or semicircular such that carts 110b travel by gravity about a cart downward directional arc “K” onto an empty cart lower return track 125. Empty cart lower return track 125 is positioned directly below unloading upper cart track 113 and can include each of a fixed lower track support structure 126, a cart support track portion 128, and a lower track cart retention portion 130. The carts traveling on empty cart lower return track 125 move in an empty cart return direction “L” to a temporary stop position identified as cart 110e. Empty cart return direction “L” is opposite to offload transit direction “J.” When carts are positioned on empty cart lower return track 125, a product interface surface 132 of the carts faces downward and opposite to the orientation provided when the carts are positioned on either cart upper track portion 112 or unloading upper cart track 113.

After reaching the temporary stop position shown at cart 110e, the carts are grouped for collective repositioning onto a cart lower track portion 134 of movable cart transfer device 106. This is accomplished by use of each of a first cart retention/release device 136 and a second cart retention/release device 138. The first and second cart retention/release devices 136, 138 are spaced to permit a predetermined quantity of carts, identified as carts 110g, to be temporarily restrained for subsequent movement as a group onto cart lower track portion 134. Carts of the group identified as carts 110g when positioned on cart lower track portion 134 are identified as carts 110h. The quantity of carts in the group represented as carts 110h is determined by the length of a lower track support 140. Carts moving onto movable cart transfer device 106 from empty cart lower return track 125 also move in the empty cart return direction “L” because cart lower track portion 134 is aligned collinear with and oriented at the same angle or pitch as empty cart lower return track 125.

The members of direction reversing conveyor assembly 107 are connected to at least one each of a first fixed stanchion 142 and a second fixed stanchion 144 which are fixedly connected to a ground surface 146. Movable cart transfer device 106 is movable with respect to direction reversing conveyor assembly 107 through the use of first wheels 148, 148′ and second wheels 150, 150′ (first and second wheels 148′, 150′ are not visible in this view). Movable cart transfer device 106 can therefore be moved toward or away from direction reversing conveyor assembly 107 to unload or reload carts 110a or 110h remotely from the direction reversing conveyor assembly 107. This permits the carts to be moved closer to a storage site of products 122 if the storage site is remote from direction reversing conveyor assembly 107.

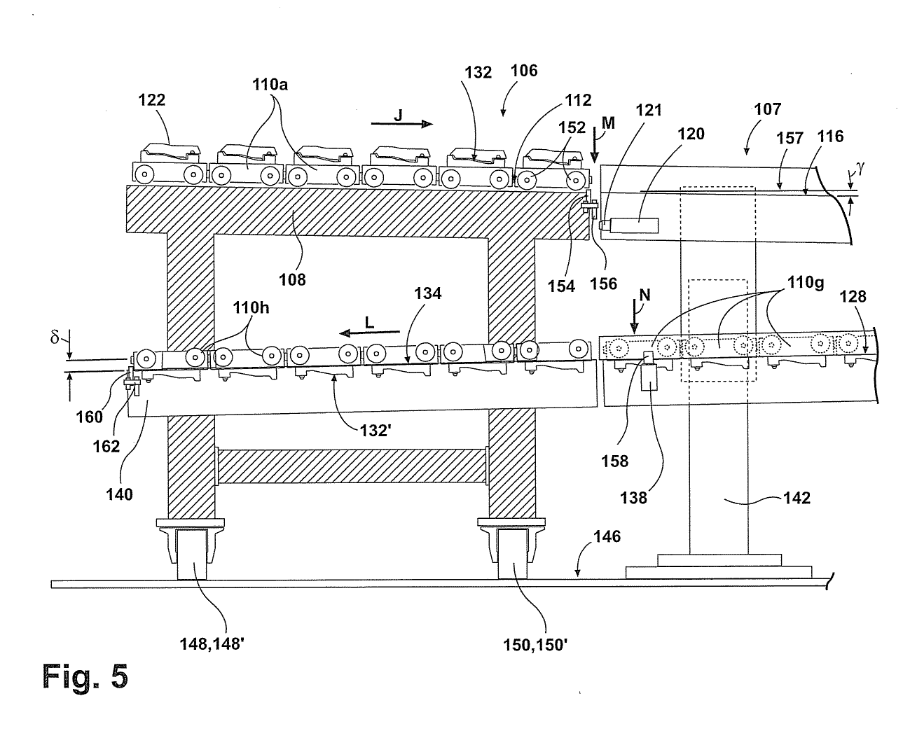

Referring to FIG. 5, each of the carts 110, for example carts 110a include at least one and according to several embodiments a plurality of concave perimeter wheels 152. Concave perimeter wheels 152 are adapted to align with cart upper track portion 112 such that carts 110a each move in a coaxial manner with respect to each other. Carts 110a are temporarily restrained on cart upper track portion 112 by a displaceable stop member 154 which upwardly extends from a release device 156. Release device 156 can be tripped when contact is made between moveable cart transfer device 106 and direction reversing conveyor assembly 107 such that carts 110a roll off cart upper track portion 112 and onto unloading upper cart track 113. Both cart upper track portion 112 and unloading upper cart track 113 are pitched or sloped at an angle gamma (γ) which is measured with respect to a reference plane 157 oriented parallel to ground surface 146.

Carts 110g on cart lower return track 125 are retained until a piston stop 158 of second cart retention/release device 138 is displaced in a release direction “N” permitting carts 110g to collectively move in the empty cart return direction “L” onto cart lower track portion 134. Carts 110h on cart lower track portion 134 are temporarily retained by a second displaceable stop member 160 extending vertically upward with respect to cart lower track portion 134. Second displaceable stop member 160 is connected to a second release device 162 which can be manually or automatically tripped to allow carts 110h to continue movement in the empty cart return direction “L” when desired. As most clearly evident in FIG. 5, product interface surfaces 132 of carts 110a are oriented generally vertically upward and opposite to the orientation of product interface surfaces 132′ of carts 110h. It is therefore necessary to reorient the carts positioned as carts 110h to the orientation shown for carts 110a for reloading with additional product 122.

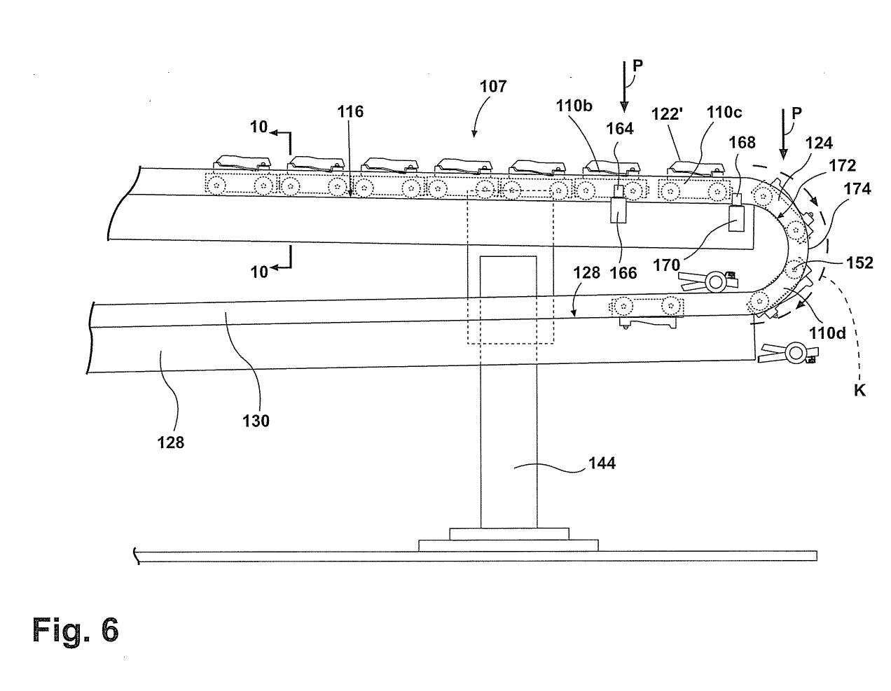

Referring to FIG. 6, the operation using downward curved track portion 124 proceeds as follows. Carts 110b in the temporary retention position shown on unloading upper cart track 113 are restrained by a piston stop 164 extending vertically upward from a third retention/release device 166. Third retention/release device 166 can be manually or automatically operated, for example using pressurized air, to retract or extend piston stop 164. When piston stop 164 is retracted in release direction “P” from the position shown, individual carts 110b will move to the right as shown in FIG. 6 to the position of cart 110c and temporarily held in position by a piston stop 168 of a fourth cart retention/release device 170. Fourth cart retention/release device 170 operates similar to third cart retention/release device 166. With piston stop 168 extended vertically as shown, product 122′ is removed from cart 110c and then piston stop 168 is retracted in the release direction “P” such that cart 110c rolls to the right and into downward curved track portion 124 at the position shown as cart 110d. Downward curved track portion 124 includes each of a loop portion inner track 172 and a loop portion outer track 174 which allow the downward movement of cart 110d about the cart reverse directional arc “K” while preventing cart 110d from dislodging from the downward curved track portion 124. As the cart 110 moves out of downward curved track portion 124 it moves onto and is supported by empty cart lower return track 125. Operation of the third and fourth cart retention/release devices 166, 170 can be an automatic operation, for example by a computer system (not shown), which can time or sequence the operation of these devices, or by manual release or control by an operator (not shown) located at the position of product 122′ during offload of product 122′.

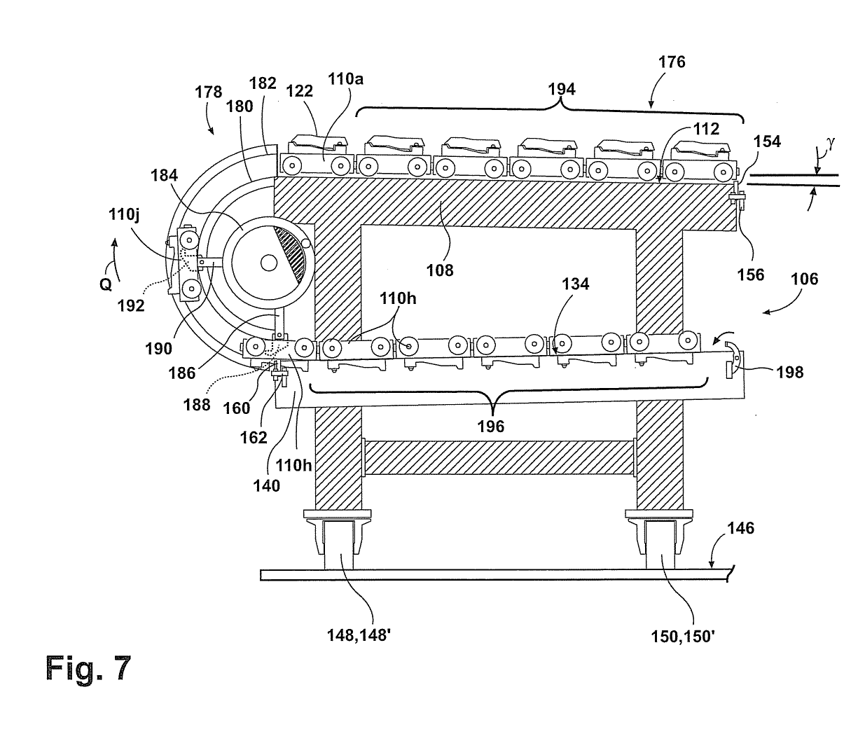

Referring to FIG. 7, movable cart transfer device 106 can provide additional features shown with a modified mobile cart transfer device 176 to include a track upward loop portion 178. Addition of track upward loop portion 178 permits carts 110h to be returned to cart upper track portion 112 against the force of gravity without moving movable cart transfer device 106 with respect to direction reversing conveyor assembly 107.

Track upward loop portion 178 can include a loop portion inner track 180 and a loop portion outer track 182 which are similar in function to loop portion inner and outer tracks 172, 174 shown and described with reference to FIG. 6. A rotating device 184 such as a counter-balanced wheel rotatably connected to movable cart transfer device 106 and/or track upward loop portion 178 can include an engagement arm 186. An engagement member 188 extending from engagement arm 186 is positioned to contact cart 110h at the furthest left position shown in FIG. 7 to move cart 110h into track upward loop portion 178 and toward the position of cart 110j shown. Rotating device 184 can be manually rotated or powered, such as by an air or electric motor turning a rack gear. Track upward loop portion 178 can also include a second engagement arm 190 having a second engagement member 192 which allows more than one of the carts 110h/110j to be moved at the same time about a cart return direction arc “Q.” First and second engagement arms 186, 190 can be either automatically (by powered operation) or manually displaced at the discretion of the designer. Loop portion inner and outer tracks 180, 182 allow rolling motion of carts 110j, 110h while preventing misalignment of the carts or displacement from the gravity conveyor assembly as they travel back to cart upper track portion 112.

The quantity of carts in the group represented as carts 110a is determined by the length of the upper track support 108 and cart upper track portion 112 of movable cart transfer device 106 and are gravity unloaded as a group 194. The quantity of carts in the group represented as carts 110h is determined by the length of a lower track support 140 and cart lower track portion 134 of movable cart transfer device 106 and are gravity loaded as a group 196. A rotatable, gravity-return, one-way loading latch 198 can be used which can rotate away from the upright position in a counterclockwise direction as shown by the arrow to permit carts 110h to load onto cart lower track portion 134 while preventing carts 110h from moving in an opposite direction when loading latch 198 swings clockwise by gravity to the upright position shown.

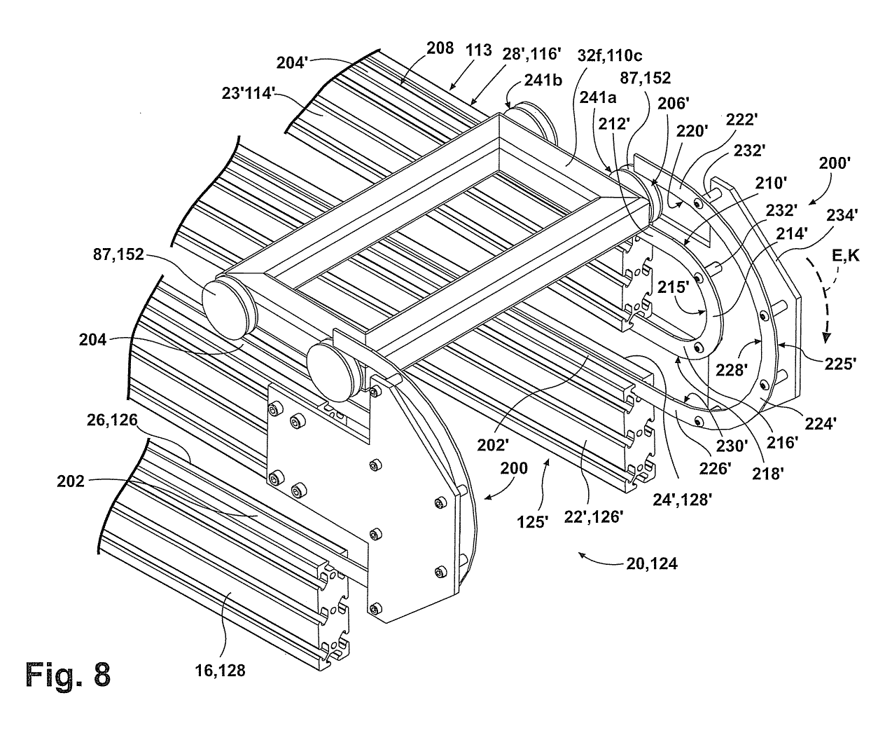

Referring to FIG. 8, each of first curved track member 20 and downward curved track portion 124 can be similarly constructed as mirror image curved track assemblies 200, 200′. Only curved track assembly 200′ will therefore be further described. Curved track assembly 200′ includes a first metal rail 202′ upwardly extending from the cart support portion 24′ or 128′ of the track support structure 22′ or 126′. Similarly, a second metal rail 204′ upwardly extends from the cart support portion 28′ or 116′ of the track support structure 23′ or 114′. A cart such as cart 32f or 110c shown in the temporary stop position has a concave curved surface 206′ of the concave perimeter wheels 87, 152 supported on an upper surface 208′ of metal rail 204′ until the cart moves into curved track assembly 200′. As the cart 32f or 110c moves into curved track assembly 200′, concave curved surface 206′ of the concave perimeter wheel 87 or 152 is supported on an upward facing surface 210′ of a straight first leg 212′ of a generally horseshoe-shaped first curved rail 214′. First leg 212′ is positioned to abut an end of the second metal rail 204′. First leg 212′ transitions into a semicircular portion 215′ of first curved rail 214′. A straight second leg 216′ extends from an opposite end of semicircular portion 215′ facing a similar direction as first leg 212′. Second leg 216′ abuts the retention portion 130 (not shown) of cart lower return track 125. Semicircular portion 215′ has less than 180 degrees (approximately 178 degrees) of rotation arc to align first leg 212′ with the pitch of second rail 204′ and to align second leg 216′ with the pitch of retention portion 130 of cart lower return track 125. As concave perimeter wheel 87 or 152 travels from the initial position shown proximate to first leg 212′ more than 90 degrees of rotation about the arc of curvature “E” or “K,” second leg 216′ now acts not in direct support, but to retain concave perimeter wheel 87 or 152 such that a lower facing surface 218′ of second leg 216′ is positioned partially within the constraining walls of but clears the concave curved surface 206′.

Also as the cart 32f or 110c moves into curved track assembly 200′, a lower facing surface 220′ of a straight first leg 222′ of a horseshoe-shaped second curved rail 224′ is positioned partially within the concave shaped space created by the concave curved surface 206′ of the concave perimeter wheel 87 or 152. The lower facing surface 220′ is maintained at a clearance from concave curved surface 206′ to prevent concave perimeter wheel 87 or 152 from moving clear from curved rail 214′. First leg 222′ is positioned to abut an end of the retention portion 118 (not shown) of upper cart track 113. First leg 222′ transitions into a semicircular portion 225′ of second curved rail 224′. A straight second leg 226′ extends from an opposite end of semicircular portion 225′ facing a similar direction as first leg 222′. Second leg 226′ abuts an end of first rail 202′. Semicircular portion 225′ has less than 180 degrees (approximately 178 degrees) of rotation arc to align first leg 222′ with the pitch of the retention portion 118 (not shown) of upper cart track 113 and to align second leg 226′ with the pitch of first rail 202′. A semicircular surface 228′ of second curved rail 224′ is continuously partially received in the concave shaped space of concave curved surface 206′ to retain concave perimeter wheel 87 or 152 until concave perimeter wheel 87 or 152 travels more than 90 degrees about arc of curvature “E” or “K,” at which time semicircular surface 228′ and then an upward facing surface 230′ of a second leg of second curved rail 224′ acts to support concave perimeter wheel 87 or 152 for further travel onto first metal rail 202′. First and second curved rails 214′, 224′ can be connected using fasteners 232′ to a metal plate 234′. Metal plate 234′ retains the spacing and stiffness of first and second curved rails 214′, 224′. The cart retention portions of the cart tracks which abut both second leg 216′ and first leg 222′ are not shown in this view for clarity.

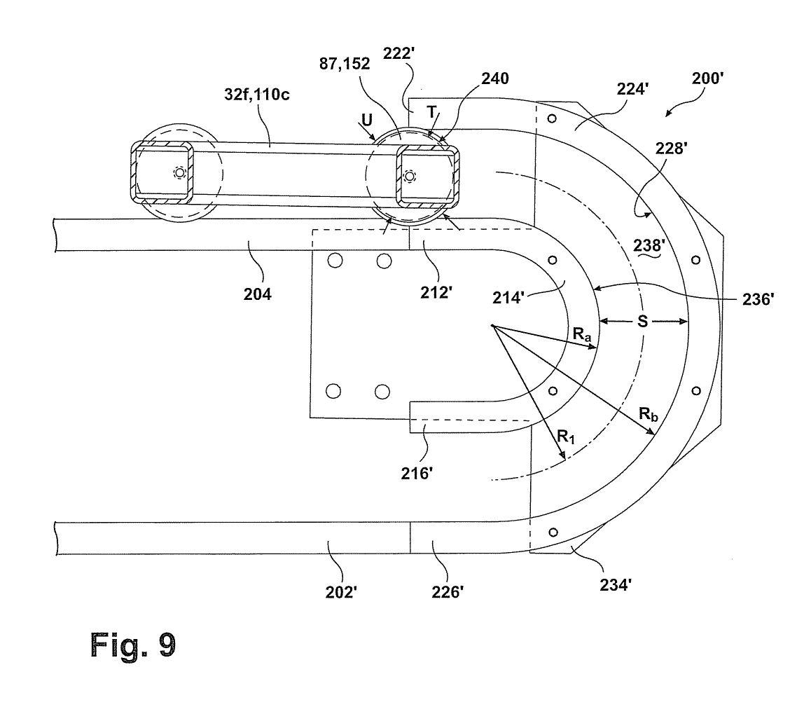

Referring to FIG. 9, first curved rail 214′ has an outer radius Rₐ, and semicircular surface 228′ of second curved rail 224′ has an inner radius R_{b}. A span dimension “S” between outer radius 236′ and inner radius 228′ defines a curved passage 238′. A contact surface 240 of concave perimeter wheels 87 and 152 has a diameter “T” that is smaller than span dimension “S” to provide clearance for passage of concave perimeter wheels 87 or 152 through curved passage 238′, while a diameter “U” defining a maximum diameter of concave perimeter wheels 87 and 152 is greater than span dimension “S” so that contact surface 240 of concave perimeter wheels 87 and 152 is retained between first and second curved rails 214′, 224′ during travel through curved passage 238′. Radius R₁ of curved passage 238′ defines a minimum radius required for simultaneous passage of forward 241a and rear 241b ones of concave perimeter wheels 87 or 152 of any one of carts 32 or 110.

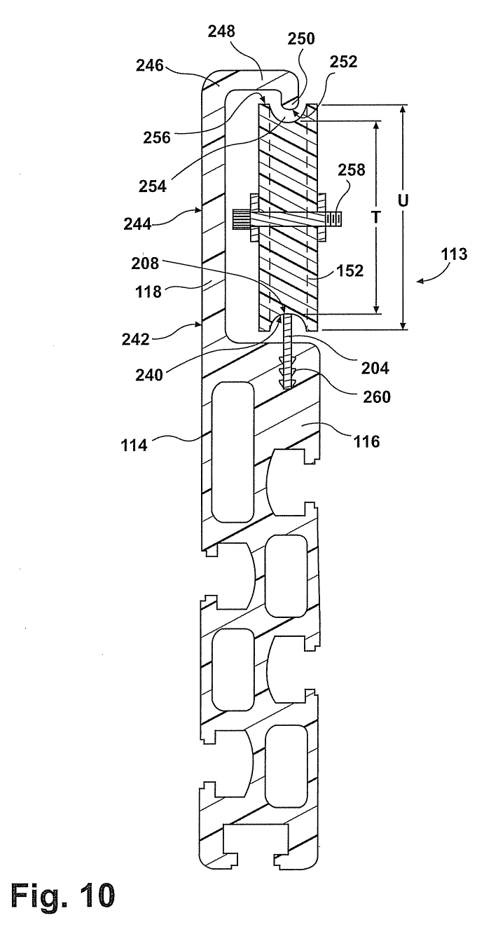

Referring to FIG. 10, upper cart track 113 is shown in cross section and provides an exemplary construction of the multiple cart tracks of the present disclosure. Track support structure 114 can be an extrusion of a metal such as aluminum having upper track support portion 116 and cart retention portion 118 homogeneously connected to upper cart track 113. An outer surface 242 of track support structure 114 is substantially coplanar and collinear with respect to an outer surface 244 of cart retention portion 118 to minimize a width of upper cart track 113. Cart retention portion 118 includes a bend 246 and an arm 248 oppositely directed with respect to outer surface 244. An extension member 250 is directed toward upper track support portion 116 and includes a rounded surface 252 which extends partially into a semispherical shaped cavity 254 and past a perimeter wall 256 of concave perimeter wheel 152. Concave perimeter wheel 152 (similar to concave perimeter wheel 87) is rotatably connected to one of the carts 110 or 32 (not visible in this view) by a centrally disposed axle 258. Concave perimeter wheel 152 is shown having contact surface 240 supported on upper surface 208 of metal rail 204. Second metal rail 204 is fixed within a cavity 260 of upper track support portion 116. Diameter “T” is smaller than a spacing between rounded surface 252 and upper surface 208, while diameter “U” is greater than this spacing to prevent concave perimeter wheel 152 from being removed or dislocated in either an up-and-down or side-to-side motion (as viewed in FIG. 9) with respect to upper cart track 113.

Gravity conveyor systems of the present disclosure offer several advantages. By providing a continuous, downward pitched path for cart travel, and connecting track sections using vertically downward curved track members, one or more track sections can be positioned directly below additional or upper track sections. This reduces the square footage or footprint of the gravity conveyor system, and allows the use of multiple, independently loaded carts to be used, which can be releasably positioned at multiple locations on the conveyor for ease of loading, unloading, or temporary storage. Conveyor systems of the present disclosure can form a closed loop having the longitudinal axis of a lower track section aligned with the longitudinal axis of an upper track section. Carts of the present disclosure can also be oriented such that products can be carried in either a suspended or a below-supported configuration while retaining movement induced only by gravity. Inclusion of an automatic or manually operated indexing device proximate to a second curved track member provides for return of empty carts to an upper track section for re-use.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A gravity conveyor assembly, comprising:
a first track member oriented at a downward pitch starting from a first end downward toward an opposite second end with respect to a first reference plane oriented parallel to a ground surface;
a second track member positioned directly above the first track member and oriented at a downward pitch starting from a second track member first end downward toward an opposite second track member second end with respect to a second reference plane oriented parallel to the ground surface;
a first curved track member connecting the second track member second end to the first track member first end, the first curved track member defining a downward oriented arc; and
a cart having at least one wheel moveable from the second track member first end to the first track member second end by gravity, a direction of travel of the cart reversing from a first direction of travel on the second track member to an opposite second direction of travel on the first track member as the cart downwardly traverses the first curved track member.

2. The gravity conveyor assembly of claim 1, wherein the cart includes a product support surface oriented facing upward when the cart is supported by the second track member and oppositely oriented facing downward when the cart is supported by the first track member.

3. The gravity conveyor assembly of claim 2, further including a hook member extending from the product support surface, the hook member oriented to suspend a product below the cart when the cart is supported on the first track member for delivery of the product from the first track member first end to the first track member second end.

4. The gravity conveyor assembly of claim 1, wherein the at least one wheel comprises four wheels, having two of the four wheels rotatably connected to each of opposite first and second sides of the cart.

5. The gravity conveyor assembly of claim 4, wherein each of the first and second track members and the first curved track member include a retention portion, the retention portion partially extending into a concave curved portion of the at least one wheel to prevent dislocation of the cart from the gravity conveyor assembly during cart travel.

6. The gravity conveyor assembly of claim 4, further including two parallel oriented metal rails supported on and extending from each of the first and second track members, the metal rails each partially received within the concave curved portion of two of the four wheels.

7. The gravity conveyor assembly of claim 1, further including:
an unloading conveyor portion having:
a third track oriented collinear to the first track member section having first and second ends, with the first end of the third track section connected to the second end of the first track section; and
a fourth track section oriented collinear to the second track member and having first and second ends, with the second end of the fourth track member connected to the first end of the second track section; and
a second curved track member connecting the second end of the third track member to the first end of the fourth track member, the second curved track member having an upward arc path to permit moving the cart from the third track member to the fourth track member in the second curved track member by a lifting force applied to the cart.

8. The gravity conveyor assembly of claim 7, further including:
an indexing device connected to at least one of the third and fourth track sections proximate to the second curved track member; and
at least one arm extending from the indexing device positioned to contact the at least one cart, wherein a rotational force applied to the indexing device co-rotates the arm to apply the lifting force to the at least one cart.

9. The gravity conveyor assembly of claim 1, further comprising a movable cart transfer device, including:
an upper track portion adapted to support the cart and aligned so that the cart moves by gravity induced motion from the upper track portion onto the second track member; and
a lower track portion aligned with the first track member to receive the cart from the first track member by gravity induced motion.

10. The gravity conveyor assembly of claim 9, further including a product support surface of the cart, wherein when the cart is received on the lower track portion the product support surface is oriented downward, opposite to an upward orientation of the product support surface when the cart is positioned on the upper track portion and the first track member.

11. The gravity conveyor assembly of claim 1, further including a second track member longitudinal axis oriented parallel to a first track member longitudinal axis, the first track member longitudinal axis being positioned directly below the second track member longitudinal axis, and the downward oriented arc of the first curved track member is oriented vertically downward.

12. A gravity conveyor assembly, comprising:
a first track member continuously downwardly pitched starting from a first end toward an opposite second end;
a second track member positioned entirely above the first track member, the second track member continuously downwardly pitched starting from a second track member first end toward an opposite second track member second end;
a first curved track member connecting the second track member second end to the first track member first end, the first curved track member defining a downward oriented arc;
a second curved track member connecting the second end of the first track member to the first end of the second track member, the second curved track member defining an upward oriented arc; and
a cart having at least one wheel and moveable from the second track member first end to the first track member second end by gravity, a direction of travel of the cart reversing from a first direction of travel on the second track member to an opposite second direction of travel on the first track member as the cart traverses the first curved track member from the second track member to the first track member, the cart movable against gravity in the upward oriented arc of the second curved track member to return the cart from the first track member to the second track member.

13. The gravity conveyor assembly of claim 12, wherein each of the first and second track members and the first and second curved track members include a retention portion.

14. The gravity conveyor assembly of claim 12, wherein the retention portion partially extends into a concave curved portion of the at least one wheel to prevent dislocation of the cart from the gravity conveyor assembly during cart travel.

15. The gravity conveyor assembly of claim 12, further including a product support surface of the cart, wherein the cart received on the first track member has the product support surface suspended facing downward, opposite to an upward facing orientation of the product support surface when the cart is positioned on the second track member.

16. The gravity conveyor assembly of claim 12, further including at least one extendable stop device operating when in an extended position to temporarily retain the cart.

17. The gravity conveyor assembly of claim 12, further including:
a first curved track member radius R₁ is a minimum bend radius that permits travel of the cart through the first curved track member; and
a second curved track member radius R₂ is larger than radius R₁.

18. A gravity conveyor assembly, comprising:
a direction reversing conveyor assembly, including:
a first track member oriented at a downward pitch starting from a first end downward toward an opposite second end with respect to a first reference plane oriented parallel to a ground surface;
a second track member positioned directly above the first track member and oriented at a downward pitch starting from a second track member first end downward toward an opposite second track member second end with respect to a second reference plane oriented parallel to the ground surface;
a curved track member connecting the second track member second end to the first track member first end, the first curved track member defining a downward oriented arc; and
a movable cart transfer device, including:
an upper track portion adapted to support a plurality of carts and aligned so that the carts move by gravity induced motion onto the second track member at the second track member second end; and
a lower track portion aligned with the second end of the first track member to receive any of the carts positioned on the first track member by gravity induced motion, the carts when received on the lower track portion having a product support surface oriented downward, opposite to an upward orientation of the product support surface for any of the carts positioned on the upper track portion or the first track member.

19. The gravity conveyor assembly of claim 18, further including a contact signaling device mounted on one of the vertically looped conveyor assembly or the movable cart transfer device, the contact signaling device operating to send a signal when contact occurs between the vertically looped conveyor assembly and the movable cart transfer device.

20. The gravity conveyor assembly of claim 18, further including at least one extendable stop device operating when in an extended position to temporarily retain any one of the plurality of carts, the extendable stop device triggered to release the any one cart when contact occurs between the vertically looped conveyor assembly and the movable cart transfer device.

21. The gravity conveyor assembly of claim 18, wherein the plurality of carts individually include at least one wheel and are moveable from the second track member first end to the first track member second end by gravity induced motion, a direction of travel of the carts reversing from a first direction of travel on the second track member to an opposite second direction of travel on the first track member as the plurality of carts individually downwardly traverse the first curved track member.

22. The gravity conveyor assembly of claim 18, wherein the curved track member downward oriented arc defines a vertically downward oriented arc.

23. The gravity conveyor assembly of claim 18, further including a second curved track member connected to the movable cart transfer device connecting the lower track portion to the upper track portion, the second curved track member defining an upward oriented arc for transfer of individual ones of the plurality of carts against gravity from the lower track portion to the upper track portion.

24. A gravity conveyor assembly, comprising:
a first track member oriented at a downward pitch starting from a first end downward toward an opposite second end with respect to a first reference plane oriented parallel to a ground surface, and including parallel first metal rails upwardly extending from a cart support portion of first parallel track support structures;
a second track member positioned directly above the first track member and oriented at a downward pitch starting from a second track member first end downward toward an opposite second track member second end with respect to a second reference plane oriented parallel to the ground surface, and including parallel second metal rails upwardly extending from a second cart support portion of second parallel track support structures; and
a curved track member connecting the second track member second end to the first track member first end, the curved track member including mirror image track member assemblies each including:
a first curved rail having a first leg abutting the second metal rail and a second leg abutting a retention portion of the second track member, and a semicircular portion between the first and second, first curved rail legs; and
a second curved rail having a first leg abutting a retention portion of the first track member and a second leg abutting the first metal rail, and a semicircular portion between the first and second, second curved rail legs.

25. The gravity conveyor assembly of claim 24, wherein the semicircular portion of each of the first and second curved rails has less than 180 degrees of rotation arc.

26. The gravity conveyor assembly of claim 24, wherein the semicircular portion of each of the first and second curved rails has approximately 178 degrees of rotation arc.

27. The gravity conveyor assembly of claim 24, further including at least one cart having a concave curved surface of each of a plurality of concave perimeter wheels for gravity travel on an upper surface of the first and second metal rails.

28. The gravity conveyor assembly of claim 27, further including:
an outer radius of the first curved rail;
a semicircular surface of the second curved rail having an inner radius such that a span dimension between the first curved rail and the semicircular surface of the second curved rail defines a curved passage; and
the curved passage having a radius defining a minimum radius required for simultaneous passage of forward and rear ones of the concave perimeter wheels of the at least one cart.

29. The gravity conveyor assembly of claim 28, further including
a contact surface of the concave perimeter wheels has a diameter that is smaller than the span dimension to provide clearance for passage of the concave perimeter wheels through the curved passage; and
a diameter defining a maximum diameter of the concave perimeter wheels is greater than the span dimension so the contact surface of the concave perimeter wheels is retained between the first and second curved rails during travel through the curved passage.

30. The gravity conveyor assembly of claim 24, wherein the first and second curved rails are fastenably connected to a metal plate to retain a spacing and stiffness of the first and second curved rails.
